(19) United States
(12) Patent Application Publication
(10) Pub. No.: US 2009/0040611 A1
(43) Pub. Date: Feb. 12, 2009

(54) POLARIZING PLATE, METHOD FOR PRODUCTION THEREOF, OPTICAL FILM, AND IMAGE DISPLAY DEVICE

(75) Inventors: Yoshitsugu Kitamura, Osaka (JP); Tetsurou Ikeda, Osaka (JP); Nobuaki Iwamoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/173,453

(22) Filed: Jul. 15, 2008

(30) Foreign Application Priority Data
Aug. 8, 2007 (JP) 2007-206649

(51) Int. Cl. G02B 1/08; G02B 5/30; B29D 11/00

(52) U.S. Cl. 359/500; 264/1.34

(57) ABSTRACT

There are provided a polarizing plate that has excellent durability including both humidity resistance and heat resistance and is less likely to cause knick defects, and a method for production thereof. The polarizing plate includes: a polarizer including an iodine-containing polyvinyl alcohol resin and containing zinc; protective films each having a water-vapor permeability of 150 g/m² per 24 hours or less in an atmosphere at 40° C. and 90% RH; and an adhesive including a polyvinyl alcohol resin, a crosslinking agent and a colloidal metal compound with an average particle size of 1 to 100 nm, wherein the protective films are bonded to both side of the polarizer with the adhesive interposed between the protective layer and the polarizer.

### BACKGROUND OF THE INVENTION

1. Field of the Invention

The invention relates to a polarizing plate and a method for production thereof. The invention also relates to an optical film using the polarizing plate. The invention also relates to an image display device, such as a liquid crystal display, an organic electro-luminescence (EL) display and a plasma display panel (PDP), using the polarizing plate or the optical film.

2. Description of the Related Art

In conventional liquid crystal displays, a polarizing plate is attached to one side or both sides of a liquid crystal cell having a liquid crystal enclosed between two electrode substrates each provided with a transparent electrode depending on the image-forming mode. Such a polarizing plate generally used includes a polarizer and protective films bonded to both sides of the polarizer with a polyvinyl alcohol adhesive interposed between the polarizer and the protective film. In such a polarizing plate, the polarizer includes a polyvinyl alcohol film and a dichroic material, such as iodine or a dichroic dye, which is adsorbed to the film and oriented by drawing, and the protective films are triacetylcellulose films or the like.

In recent years, liquid crystal displays have been widely used and found a number of applications for long-term use under high-temperature conditions or the like. Therefore, there is a demand for liquid crystal displays that are less likely to cause changes in hue and meet such applications. For example, liquid crystal displays are often used for car display devices and personal digital assistances. For such applications, polarizing plates are required to have high reliability (durability) at such a level that optical properties are not degraded even when they are held at high temperature or held at high temperature and high humidity.

As a technique for improving the heat resistance of polarizing plates, there are proposed methods that include adding zinc to a polarizer or an adhesive so that the polarizer can be prevented from causing changes in hue during heating (see for example Japanese Patent Application Laid-Open (JP-A) No. 2000-35512, and JP-A No. 2003-50318). However, these methods cannot improve the humidity resistance of polarizing plates.

On the other hand, there is proposed a method that includes using a low water-vapor permeability resin film (such as a norbornene resin film) as a protective film for a polarizer instead of a triacetylcellulose film with high water-vapor permeability so that the humidity resistance of polarizing plates can be improved (see for example JP-A No. 08-5836). However, it has been confirmed that polarizing plates using such a low water-vapor permeability resin film as a protective film cause defects in optical properties due to degradation of heat resistance and so on, although they have improved humidity resistance. Even when the zinc-containing polarizer is simply bonded to the norbornene resin film as a protective film, the respective features are not exploited not to improve both humidity resistance and heat resistance, and such durability can be rather degraded in some cases.

The case where a low water-vapor permeability resin film such as a norbornene resin film is used also has a problem in which defects of local irregularities (knick defects) can easily occur as compared with the case where a high water-vapor permeability resin film such as a triacetylcellulose film is used. Knick defects significantly occur particularly when the low water-vapor permeability resin film is bonded to a polarizer with a polyvinyl alcohol adhesive interposed therebetween.

### SUMMARY OF THE INVENTION

An object of the invention is to provide a polarizing plate that includes a polarizer and protective films bonded to both sides of the polarizer with an adhesive interposed between the polarizer and the protective film, has excellent durability including both humidity resistance and heat resistance and is less likely to cause knicks, and a method for producing such a polarizing plate. Another object of the invention is to provide an optical film using such a polarizing plate and to provide an image display device using such a polarizing plate and/or such an optical film.

The objects can be achieved with a polarizing plate shown below.

The present invention relates to a polarizing plate. As shown in FIG. 1, the polarizing plate 10 has a polarizer 1, protective films 2 and 3, and an adhesive 4. The protective films 2 and 3 are bonded to both side of the polarizer 1 with the adhesive 4 interposed between the protective film and the polarizer. The polarizer includes an iodine-containing polyvinyl alcohol resin and contains zinc. Each of the protective films has a water-vapor permeability of 150 g/m² per 24 hours or less in an atmosphere at 40° C. and 90% RH. The adhesive includes a polyvinyl alcohol-based resin, a crosslinking agent, and a colloidal metal compound. The colloidal metal has an average particle size of 1 nm to 100 nm.

An amount of the colloidal metal is preferably 200 parts by weight or less based on 100 parts by weight of the polyvinyl alcohol-based resin.

In an embodiment of the invention, the colloidal metal compound preferably has a positive charge. Colloidal alumina is preferably used as a positive charged colloidal metal.

The invention is particularly favorable when the polyvinyl alcohol-based resin used in the adhesive has an acetoacetyl group.

In the adhesive for the polarizing plate, the crosslinking agent preferably contains a methylol group-containing compound.

An amount of the crosslinking agent used in the adhesive for polarizing plate is preferably of 10 to 60 parts by weight based on 100 parts by weight of the polyvinyl alcohol-based resin.

The adhesive layer of the polarizing plate preferably has a thickness of 10 nm to 300 nm, and the thickness of the adhesive layer is preferably larger than the average particle size of the colloidal metal compound contained in the adhesive.

A zinc content of the polarizer is preferably 0.002% by weight to 2% by weight.

The invention also relates to a method for producing the polarizing plate above. The method includes the steps of applying the adhesive to the polarizer and/or the protective films, laminating the polarizer and the protective films, and drying the laminate of the polarizer and the protective film. In the method of the invention, the adhesive includes a polyvinyl alcohol resin, a crosslinking agent and a colloidal metal compound with an average particle size of 1 nm to 100 nm. The polarizer includes an iodine-containing polyvinyl alcohol resin and contains zinc. The protective film has a water-vapor permeability of 150 g/m² per 24 hours or less in an atmosphere at 40° C. and 90% RH.

In the method above, a moisture content of the polarizer to be subjected to the step of laminating the polarizer and the protective films is from 12% by weight to 31% by weight, and the drying step is preferably performed at a drying temperature of 90° C. or less.

The invention also relates to an optical film. As shown in FIG. 2, the optical film 20 comprises a laminate including at least one piece of the above-described polarizing plate 10.

The invention also relates to an image display device. As shown in FIG. 3, the image display device 100 includes the above-described polarizing plate 10 or optical film 20.

### BRIEF DESCRIPTION OF THE DRAWINGS

FIG. 1 is a cross-sectional view of an example of the polarizing plate of the present invention.

FIG. 2 is a cross-sectional view of an example of the optical film of the present invention.

FIG. 3 is a cross-sectional view of an example of the image display device of the present invention.

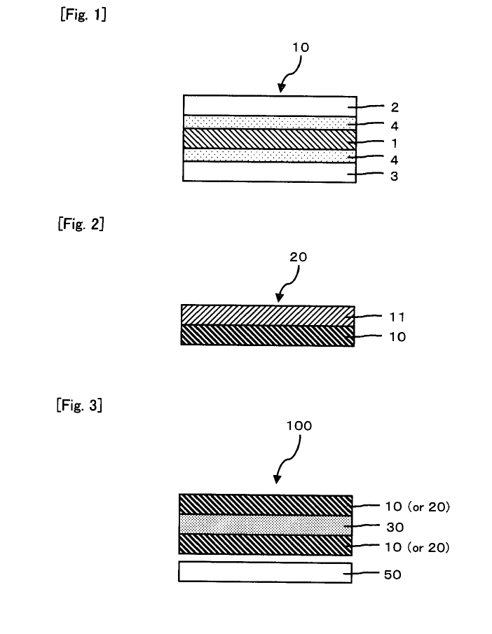

### BEST MODE FOR CARRYING OUT THE INVENTION

A description is given below of the components of the polarizing plate of the invention, the iodine-containing polarizer, the protective film with low water-vapor permeability (hereinafter also simply referred to as “protective film”) and the adhesive, and of the method for producing the polarizing plate.

Iodine-containing polyvinyl alcohol or any derivative thereof may be used as a material for the iodine-containing polarizer of the invention. Examples of the polyvinyl alcohol derivative include polyvinyl formal, polyvinyl acetal, and those modified with an olefin such as ethylene and propylene, an unsaturated carboxylic acid such as acrylic acid, methacrylic acid and crotonic acid, an alkyl ester thereof, acrylamide, or the like. The polyvinyl alcohol generally has a degree of polymerization of from about 1,000 to about 10,000 and a saponification degree of from about 80 to about 100% by mole.

The polyvinyl alcohol-based film may contain any additive such as a plasticizer. Examples of the plasticizer include polyols and condensation products thereof, such as glycerol, diglycerol, triglycerol, ethylene glycol, propylene glycol, and polyethylene glycol. While the plasticizer may be used in any amount, the content of the plasticizer in the polyvinyl alcohol-based film is preferably 20% by weight or less.

The polarizer of the invention can be produced by subjecting the polyvinyl alcohol-based film (unstretched film) to at least a uniaxial stretching step, and an iodine dyeing step. In addition, a boric acid treatment and/or a potassium iodide treatment may be performed. The processed polyvinyl alcohol-based film (stretched film) may be dried according to conventional methods so that a finished polarizer can be obtained.

In the uniaxial stretching step, any stretching method, for example, any of a wet stretching method and a dry stretching method may be used. Examples of dry stretching methods include stretching between rolls, heating roll stretching, and compression stretching. The stretching may be performed in a multistage manner. In the dry stretching method, the unstretched film is generally heated. In general, unstretched film having a thickness of approximately 30 to 150 μm is used. While the film may be stretched at any proper stretch ratio depending on purpose, the stretch ratio (total stretch ratio) may be from about 2 to about 8, preferably from 3 to 6.5, more preferably from 3.5 to 6. The stretched film preferably has a thickness of 5 to 40 μm.

The iodine dyeing step may be performed by immersing the polyvinyl alcohol-based film in the iodine solution containing iodine and potassium iodide. The iodine solution is generally an aqueous iodine solution which contains iodine and potassium iodide as an auxiliary agent. While the iodine may be at any concentration, the iodine concentration may be from about 0.01 to about 1% by weight, preferably from 0.02 to 0.5% by weight. While the potassium iodide may be at any concentration, the potassium iodide concentration may be from about 0.01 to about 10% by weight, preferably from 0.02 to 8% by weight.

In the iodine dyeing step, the iodine solution generally has a temperature of from about 20 to about 50° C., preferably from 25 to 40° C. The immersion time period is generally from about 10 to about 300 seconds, preferably from 20 to 240 seconds. In the iodine dyeing step, the conditions including the concentration of the iodine solution and the temperature and/or time period of the immersion of the polyvinyl alcohol-based film in the iodine solution may be controlled such that the contents of iodine and potassium in the polyvinyl alcohol-based film can be in the above ranges, respectively. The iodine dyeing step may be performed at any stage before the uniaxial stretching step, during the uniaxial stretching step, or after the uniaxial stretching step.

The boric acid treatment may be performed by immersing the polyvinyl alcohol-based film in an aqueous boric acid solution. The concentration of boric acid in the aqueous boric acid solution may be from about 2 to about 15% by weight, preferably from 3 to 10% by weight. The aqueous boric acid solution may contain potassium ion and iodine ion derived from potassium iodide. The concentration of potassium iodide in the aqueous boric acid solution may be from about 0.5 to about 10% by weight, preferably from 1 to 8% by weight. Using the aqueous boric acid solution containing potassium iodide, a so-called neutral gray polarizer can be produced which is less colored or substantially uniform in absorbance over substantially the entire range of visible light wavelengths.

In the boric acid treatment, the aqueous boric acid solution may have a temperature of 30° C. or higher, preferably from 40 to 85° C. The immersion time period is generally from about 1 to about 1,200 seconds, preferably from 10 to 600 seconds, more preferably from 20 to 500 seconds. The boric acid treatment may be performed after the iodine dyeing step. The boric acid treatment may also be performed during or after the uniaxial stretching step. The boric acid treatment may be performed plural times.

In the potassium iodide treatment, iodine containing aqueous solution such as using potassium iodide is preferably used. The potassium iodide concentration of the solution is generally from about 0.5 to about 10% by weight, preferably from 1 to 8% by weight. The process temperature is generally the range of from 15 to 60° C., preferably from 25 to 40° C. The immersion time period is generally from about 1 to about 120 seconds, preferably from 3 to 90 seconds. The potassium iodide treatment may be performed at any stage before the drying step. It can be performed after the washing step mentioned later.

The polarizer used for the present invention contains zinc. Containing zinc in a polarizer is preferable, because a hue deterioration of a polarizing plate in high temperature conditions may be repressed. The zinc content in the polarizer may be controlled in the range approximately 0.002 through 2% by weight, and preferably 0.01 through 1% by weight. When the zinc content is in the above range, a durability of the polarizer may be improved and deterioration of hue may be repressed even under high temperature conditions.

A zinc salt solution, which is generally an aqueous solution, is used in the zinc impregnating step. Examples of the zinc salt include zinc halide such as zinc chloride and zinc iodide, zinc sulfate, and zinc acetate. Zinc sulfate is preferably used as a zinc salt, because it has high retention in a polarizer. Alternatively, a wide variety of zinc complexes may be used in the impregnating step. A zinc ion concentration in the zinc salt solution is preferably about 0.1 through 10% by weight, more preferably 0.3 through 7% by weight. The zinc salt solution is preferably used in the form of an aqueous solution containing potassium ion and iodine ion derived from potassium iodide or the like, because such a solution can facilitate the impregnation of zinc ions. A potassium iodide concentration is preferably 0.5 through 10% by weight, and more preferably 1 through 8% by weight.

In the zinc impregnating step, the zinc salt solution generally has a temperature of from about 15 to about 85° C., preferably from about 25 to about 70° C. The immersion time period is generally from about 1 to about 120 seconds, preferably from 3 to 90 seconds. In the zinc impregnating step, the conditions including the concentration of the zinc salt solution and the temperature and/or time period of the immersion of the polyvinyl alcohol-based film in the zinc salt solution may be controlled such that the zinc content of the polyvinyl alcohol-based film can be in the above range. The zinc impregnating step may be performed at any stage, for example, before the iodine dyeing step, after the iodine dyeing step and before the immersion step in the aqueous boric acid solution, during the boric acid treatment, or after the boric acid treatment. The zinc impregnating step and the iodine dyeing step may be performed at the same time using the zinc salt present in the iodine dyeing solution. The zinc impregnating step is preferably performed together with the boric acid treatment. The uniaxial stretching step may be performed together with the zinc impregnating step. The zinc impregnating step may be performed plural times.

The processed polyvinyl alcohol-based film (stretched film) may be subjected to a water-washing step and a drying step according to conventional methods.

The water washing step is generally performed by immersing the polyvinyl alcohol-based film in purified water such as ion-exchange water and distilled water. The water washing temperature is generally from 5 to 50° C., preferably from 10 to 45° C., more preferably from 15 to 40° C. The immersion time period is generally from about 10 to about 300 seconds, preferably from about 20 to about 240 seconds.

The drying step may use any known conventional drying method such as natural drying, blow drying, and drying by heating. For example, in the drying by heating, the heating temperature may be from 20 to 80° C., preferably from 25 to 70° C., and the drying time may be from about 1 to about 10 minutes.

After the drying, the polarizer preferably has a moisture content of 2.0 to 5.0% by weight, more preferably of 2.5 to 3.5% by weight. When the moisture content is in the above range after the drying, a reduction in the optical properties can be prevented which would otherwise be caused by the process of drying after the lamination of the polarizer and the protective film with the adhesive interposed therebetween. If the moisture content is too high, a reduction in heat resistance or in adhesion force can tend to occur. If the moisture content is too low, problems such as knicks and uneven appearance can tend to occur. When the moisture content is in the above range, however, such degradation in optical properties can be prevented.

The protective film used as a component of the polarizing plate of the invention has a water-vapor permeability of 150 g/m² per 24 hours or less in an atmosphere at 40° C. and 90% RH. The water-vapor permeability of the protective film is preferably from 10 to 150 g/m² per 24 hours, more preferably from 30 to 120 g/m² per 24 hours, even more preferably from 50 to 100 g/m² per 24 hours. If the water-vapor permeability is beyond the above range, the polarizer can suffer from fading, a change in hue or a reduction in degree of polarization under humidified conditions. If the water-vapor permeability is too low, the adhesive can be separated during the drying. In the description, the water-vapor permeability of the film is the gram weight of water vapor passing through a sample with an area of 1 m² for 24 hours at a temperature of 40° C. and a relative humidity of 90%, which is measured by the water-vapor permeability test (cup method) according to JIS Z 0208.

In the polarizing plate of the invention having the protective films placed on both sides of the polarizer, the protective film on one side may be the same as or different from the protective film on the other side, as long as they satisfy the water-vapor permeability requirements. At least one protective film layer may be provided per side, and a laminate of two or more layers may also be used per side.

Thickness of the protective film can be properly determined and generally in the range of from about 1 to about 500 μm from a viewpoint of a strength, workability such as handlability, requirement for a thin film and the like. Especially, the thickness is preferably in the range of from 1 to 300 μm and more preferably in the range of from 5 to 200 μm. Knicks tend to occur as the thickness of the protective film decreases. Therefore, it is particularly preferred that the protective film has a thickness of 5 to 100 μm. In addition, the water-vapor permeability of the protective film can be properly adjusted by controlling its thickness.

Preferable Materials that form the protective film, which is provided one side or both sides of the polarizer is the thermoplastics having outstanding transparency, mechanical strength, heat stability and outstanding moisture interception property, or the like. If an optical isotropy is required to the protective film, the thermoplastics which show low intrinsic birefringence are preferably used. As thermoplastics of the above-mentioned protective film, for example, polyester-based resins, polyether sulfone-based resins, polysulfone-based resins, polycarbonate-based resins, polyamide-based resins, polyimide-based resins, polyolefin-based resins, (meth)acrylic-based resins, norbornene-based resins, polyarylate-based resins, and blend polymers of the above-mentioned polymers may be mentioned. Thermosetting resins or ultraviolet curing resins such as (meth)acrylic-based resins be used for the protective film. In particular, (meth)acrylic-based resins, polyimide-based resins, and norbornene-based resins are preferably used from a viewpoint of low water-vapor permeability and high optical properties. Norbornene-based resins are most preferable.

The (meth)acrylic resin preferably has a glass transition temperature (Tg) of 100° C. or more, more preferably of 105° C. or more, still more preferably of 110° C. or more, particularly preferably of 115° C. or more. If the Tg is in the above range, the resulting polarizing plate can have good durability. The upper limit to the Tg of the (meth)acrylic resin is preferably, but not limited to, 150° C. or less, in view of formability and the like.

Any appropriate (meth)acrylic-based resin may be used as long as the advantages of the invention are not reduced. Examples of such a (meth)acrylic resin include poly(meth)acrylate such as poly(methyl methacrylate), methyl methacrylate-(meth)acrylic acid copolymers, methyl methacrylate-(meth)acrylate copolymers, methyl methacrylate-acrylate-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C₁₋₆ alkyl (meth)acrylate) such as poly(methyl (meth)acrylate) is preferred, and a methyl methacrylate-based resin mainly composed of a methyl methacrylate unit (50 to 100% by weight, preferably 70 to 100% by weight) is more preferred. Examples of such a (meth)acrylic resin include ACRYPET VH and ACRYPET VRL20A, manufactured by Mitsubishi Rayon Co., Ltd.

Examples of the polyimide-based resins used in the protective film include polymer films comprising polymer composition described in JP-A No. 2001-343529 (WO 01/37007). Specifically, the composition includes thermoplastic resins having substituted and/or non-substituted imido group in side-chain, and thermoplastic resins having substituted and/or non-substituted phenyl and nitrile group in side-chain. To be more specific, such composite may comprise alternating copolymer comprising iso-butylene and N-methyl maleimide, and acrylonitrile-styrene copolymer.

Norbornene-based resin is a generic term of the resins obtained from cyclic olefin such as norbornene, tetracyclododecene and their derivatives, which is stated in, for example, JP-A No. 3-14882, and No. 3-122137 and the like. Examples thereof, to be concrete, include: a ring opening polymer of a cyclic olefin; an addition polymer of a cyclic olefin; random copolymers of a cyclic olefin and an α-olefin such as ethylene or propylene; and graft modified products obtained by modification of the above exemplified polymers with an unsaturated carboxylic acid or a derivative thereof. In addition thereto, examples thereof include hydrogenated products of the above exemplified polymers. Commercially available examples thereof include ZEONEX and ZEONOR manufactured by ZEON Corporation. ARTON manufactured by JSR Corporation, TOPAS manufactured by TICONA Inc. and the like.

The protective film may also contain at least one type of any appropriate additive. Examples of the additive include another resin, an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the protective film is preferably from 50 to 100% by weight, more preferably from 50 to 99% by weight, still more preferably from 60 to 98% by weight, particularly preferably from 70 to 97% by weight. If the content of the thermoplastic resin in the protective film is 50% by weight or less, high transparency and other properties inherent in the thermoplastic resin can fail to be sufficiently exhibited.

The protective film to be used generally has an in-plane retardation of less than 40 nm and a thickness direction retardation of less than 80 nm. The in-plane retardation Re is expressed by the formula Re=(nx−ny)×d, the thickness direction retardation Rth is expressed by the formula Rth=(nx−nz)×d, and the Nz coefficient is represented by the formula Nz=(nx−nz)/(nx−ny), where nx, ny and nz are the refractive indices of the film in the directions of its slow axis, fast axis and thickness, respectively, d is the thickness (nm) of the film, and the direction of the slow axis is a direction in which the in-plane refractive index of the film is maximum. Moreover, it is preferable that the protective film may have as little coloring as possible. A protective film having a thickness direction retardation of from −90 nm to +75 nm may be preferably used. Thus, coloring (optical coloring) of polarizing plate resulting from a protective film may mostly be cancelled using a protective film having a thickness direction retardation (Rth) of from −90 nm to +75 nm. The thickness direction retardation (Rth) is preferably from −80 nm to +60 nm, and especially preferably from −70 nm to +45 nm.

Alternatively, the protective film to be used may be a retardation plate having an in-plane retardation of 40 nm or more and/or a thickness direction retardation of 80 nm or more. The in-plane retardation is generally controlled in the range of 40 to 200 nm, and the thickness direction retardation is generally controlled in the range of 80 to 300 nm. The retardation plate for use as the protective film also has the function of the protective film and thus can contribute to a reduction in thickness.

When a retardation plate is used for the protective film, a birefringent film produced by uniaxially or biaxially stretching the above protective film is preferably used, although any material having a water-vapor permeability in the above range may be used. Alternatively, a low water-vapor permeability film with no retardation may be bonded to a birefringent film produced by uniaxially or biaxially stretching any of various polymer materials or bonded to an oriented liquid crystal polymer film or an oriented liquid crystal polymer layer supported on a film, and the resulting laminate may be used. The thickness of the retardation plate is generally, but not limited to, from about 20 to about 150 μm.

Examples of the polymer material used for the retardation plate include polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cyclic polyolefin resins (norbornene reins), and various types of binary or ternary copolymers thereof, graft copolymers thereof, and any blend thereof. Any of these polymer materials may be formed into an oriented product (a stretched film) by stretching or the like.

Examples of the liquid crystal polymer used for the retardation plate include various main-chain or side-chain types having a liquid crystal molecular orientation property-imparting conjugated linear atomic group (mesogen) introduced in a main-chain or side-chain of a polymer. Examples of the main-chain type liquid crystal polymer include polymers having a mesogen group bonded thereto via a flexibility-imparting spacer moiety, such as pneumatically ordered polyester type liquid-crystal polymers, discotic polymers, and cholesteric polymers. For example, the side-chain type liquid crystal polymer may be a polymer comprising: a main-chain skeleton of polysiloxane, polyacrylate, polymethacrylate, or polymalonate; and a side-chain having a mesogen moiety that comprises a nematic orientation-imparting para-substituted cyclic compound unit and is bonded thereto via a spacer moiety comprising a conjugated atomic group. For example, any of these liquid crystal polymers may be applied by a process that includes spreading a solution of the liquid crystalline polymer on an alignment surface such as a rubbed surface of a thin film of polyimide, polyvinyl alcohol or the like, formed on the glass plate, and an obliquely vapor-deposited silicon oxide surface, and heat-treating it.

The retardation plate may have any appropriate retardation depending on the intended use such as compensation for coloration, viewing angle, or the like due to the birefringence of various wave plates or liquid crystal layers. Two or more types of retardation plates may also be laminated to provide controlled optical properties, including retardation.

A retardation plate satisfying the relation: nx=ny>nz, nx>ny>nz, nx>ny=nz, nx>nz>ny, nz=nx>ny, nz>nx>ny, or nz>nx=ny may be selected and used depending on various applications. The relation ny=nz includes not only the case where ny is completely equal to nz but also the case where ny is substantially equal to nz.

For example, the retardation plate satisfying the relation nx>ny>nz to be used preferably has a in-plane retardation of 40 to 100 nm, a thickness retardation of 100 to 320 nm, and an Nz coefficient of 1.8 to 4.5. For example, the retardation plate satisfying the relation nx>ny=nz (positive A plate) to be used preferably has a in-plane retardation of 100 to 200 nm. For example, the retardation plate satisfying the relation nz=nx>ny (negative A plate) to be used preferably has a in-plane retardation of 100 to 200 nm. For example, the retardation plate satisfying the relation nx>nz>ny to be used preferably has a in-plane retardation of 150 to 300 nm and an Nz coefficient of more than 0 and not more than 0.7. As described above, for example, the retardation plate satisfying the relation nx=ny>nz, nz>nx>ny or nz<nx=ny may also be used.

A preferable range of retardation value of the protective film may be appropriately determined depending on the liquid crystal display to be produced therewith. In the case of VA (Vertical Alignment, including MVA and PVA) mode LCD, it is preferred that the protective film on at least one side of the polarizing plate (on the cell side) has a retardation. Specifically, it preferably has a retardation Re in the range of 0 to 240 nm and a retardation Rth in the range of 0 to 500 nm. In terms of three-dimensional refractive index, the case of nx>ny=nz, nx>ny>nz, nx>nz>ny, or nx=ny>nz (uniaxial, biaxial, Z conversion, negative C-plate) is preferred. When polarizing plates are used on upper and lower sides of a liquid crystal cell, the protective films may have a retardation on upper and lower sides of the liquid crystal cell, or one of the upper and lower protective films may has a retardation.

For example, in the case of IPS (In-Plane Switching, including FFS) mode LCD, the protective film for use in one of the polarizing plates may have or may not have a retardation. For example, a protective film with no retardation is preferably provided on both upper and lower sides of a liquid crystal cell (cell sides), or otherwise a protective film with a retardation is preferably provided on both or one of the upper and lower sides of a liquid crystal cell (for example, Z conversion on the upper side with no retardation on the lower side or an A-plate provided on the upper side with a positive C-plate provided on the lower side). When it has a retardation, it preferably has a retardation Re in the range of −500 to 500 nm and a retardation Rth in the range of −500 to 500 nm. In terms of three-dimensional refractive index, nx>ny=nz, nx>nz>ny, nz>nx=ny, or nz>nx>ny (uniaxial, Z conversion, positive C-plate, positive A-plate) is preferred.

An easy adhesion treatment can be applied onto a surface of a protective film which is adhered to a polarizer. Examples of easy adhesion treatments include: dry treatments such as a plasma treatment and a corona treatment; chemical treatment such as alkaline treatment (saponification); and a coating treatment in which an easy adhesion layer is formed. Among them, preferable are a coating treatment and an alkaline treatment each forming an easy adhesion layer. In formation of an easy adhesion layer, there can be used each of various kinds of easy adhesion materials such as a polyol resin, a polycarboxylic resin and a polyester resin. Note that a thickness of an easy adhesion layer is preferably usually from about 0.001 to about 10 μm, more preferably from about 0.001 to about 5 μm and especially preferably from about 0.001 to about 1 μm.

A hard coat layer may be prepared, or antireflection processing, processing aiming at sticking prevention, diffusion or anti glare may be performed onto the face on which the polarizing film of the above described protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film.

The adhesive for polarizing plate of the invention is a resin solution including a polyvinyl alcohol-based resin, a crosslinking agent and a colloidal metal compound with an average particle size of 1 to 100 nm.

The polyvinyl alcohol-based resin may be a polyvinyl alcohol resin or an polyvinyl alcohol-based resin having an acetoacetyl group. The polyvinyl alcohol-based resin having an acetoacetyl group can form a highly reactive functional group-containing polyvinyl alcohol-based adhesive and thus is preferred because it can increase the durability of the polarizing plate.

Examples of polyvinyl alcohol-based resin include: a polyvinyl alcohol obtained by saponifying a polyvinyl acetate; a derivative thereof; a saponified copolymer of vinyl acetate and a monomer copolymerizable therewith; and polyvinyl alcohols modified by acetalization, urethanization, etherification, grafting, phosphate esterification and the like. Examples of the monomers include, unsaturated carboxylic acids such as maleic anhydride, fumaric acid, crotonic acid, itaconic acid and (meth) acrylic acid, and esters thereof; α-olefins such as ethylene and propylene; (meth)allylsulfonic acid or sodium salt thereof, (meth)allylsulfonate; sodium sulfonate (monoalkyl maleate), sodium disulfonate (alkyl maleate); N-methylolacrylamide; an alkali salt of acrylamide alkylsulfonate; N-vinylpyrrolidone, a derivative of N-vinylpyrrolidone and the like. The polyvinyl alcohol-based resins can be either used alone or in combination of two kinds or more.

While no specific limitation is imposed on a polyvinyl alcohol-based resin, an average degree of polymerization is from about 100 to about 5000, preferably from 1000 to 4000 and an average degree of saponification is from about 85 to about 100 mol %, preferably from 90 to 100 mol % in consideration of adherence.

A polyvinyl alcohol-based resin having an acetoacetyl group is obtained by reacting a polyvinyl alcohol-based resin and diketene to each other with a known method. Examples of known methods include: a method in which a polyvinyl alcohol-based resin is dispersed into a solvent such as acetic acid, to which diketene is added and a method in which a polyvinyl alcohol-based resin is previously dissolved into a solvent such as dimethylformamide or dioxane, to which diketene is added. Another example is a method in which diketene gas or diketene liquid is brought into direct contact with a polyvinyl alcohol.

No specific limitation is imposed on a degree of modification by an acetoacetyl group in a polyvinyl alcohol-based resin having an acetoacetyl group or groups as far as the degree of modification is 0.1 mol % or more. If the degree of modification is less than 0.1 mol %, water resistance of an adhesive layer is insufficient, which is improper. A degree of modification by an acetoacetyl group is preferably from about 0.1 to about 40 mol %, more preferably from 2 to 7 mol %. If a degree of modification by an acetoacetyl group exceeds 40 mol %, reaction sites with a crosslinking agent is fewer to thereby reduce an effect of improvement on moisture resistance and heat resistance. The degree of modification by an acetoacetyl group can be determined by NMR.

Any of crosslinking agents that have been used in a polyvinyl alcohol-based adhesive can be used as a crosslinking agent in the invention without a specific limitation thereon. A crosslinking agent that can be used is a compound having at least two functional groups having reactivity with a polyvinyl alcohol-based resin. Examples thereof include: alkylene diamines having an alkylene group and two amino groups such as ethylene diamine, triethylene diamine and hexamethylene diamine; isocyanates such as tolylene diisocyanate, hydrogenated tolylene diisocyanate, trimethylolpropane tolylene diisocyanate adduct, triphenylmethane triisocyanate, methylenebis(4-phenylmethane) triisocyanate and isophorone diisocyanate, and ketoxime-blocked products thereof or isocyanates of phenol-blocked products; epoxy compounds such as ethylene glycol diglycidyl ether, polyethylene glycol diglycidyl ether, glycerin di- or triglicydyl ether, 1,6-hexanediol diglycidyl ether, trimethylolpropane triglycidyl ether, diglicidyl aniline and diglycidyl amine; monoaldehydes such as formaldehyde, acetaldehyde, propionaldehyde and butylaldehyde; dialdehydes such as glyoxal, malonaldehyde, succindialdehyde, glutardialdehyde, maleic dialdehyde and phthaldialdehyde; amino-formaldehyde resins such as condensates with formaldehyde of methylolurea, methylolmelamine, alkylated methylolurea, alkylated methylolmelamine, acetoguanamine and benzoguanamine; salts of divalent metals or trivalent metals such as sodium, potassium, magnesium, calcium, aluminum, iron and nickel, and oxides of the metals. In particular, amino-formaldehyde resins and dialdehydes are preferred. Amino-formaldehyde resins preferably include methylol group-containing compounds, and dialdehydes preferably include glyoxal. Methylolmelamine, a methylol group-containing compound, is particularly preferred.

While the amount of the crosslinking agent to be blended may be appropriately determined depending on the type of the polyvinyl alcohol-based resin and the like used in the adhesive, it is generally from about 10 to about 60 parts by weight, preferably from 20 to 50 parts by weight, based on 100 parts by weight of the polyvinyl alcohol-based resin. In such ranges, good adhesion properties can be obtained.

In order to increase durability of the polarizing plate, a polyvinyl alcohol-based resin having an acetoacetyl group may be used. Also in this case, the crosslinking agent may be used in an amount of 10 to 60 parts by weight, preferably in an amount of about 20 to about 50 parts by weight, similarly to the above, based on 100 parts by weight of the polyvinyl alcohol-based resin. If the amount of the crosslinking agent to be blended is too large, the reaction of the crosslinking agent can proceed within a short time so that the adhesive can tend to form a gel, and as a result, the adhesive can have an extremely short pot life and thus can be difficult to use industrially. From these points of view, the crosslinking agent is used in the above amount, but the resin solution according to the invention can be stably used even when the amount of the crosslinking agent is large as mentioned above, because the resin solution contains the colloidal metal compound.

The colloidal metal compound is a dispersion of fine particles in a dispersion medium and can have permanent stability, because the fine particles are electrostatically stabilized by the repulsion between the fine particles charged with the same type of charge. The colloidal metal compound (fine particles) has an average particle size of 1 to 100 nm. If the average particle size of the colloid is in this range, the metal compound can be almost uniformly dispersed in the adhesive layer so that knicks can be prevented, while adhesive properties can be ensured. The average particle size in this range is considerably smaller than the wavelength in the visible light range. Thus, the metal compound has no harmful effect on the polarization properties, even when the transmitted light is scattered by the metal compound in the formed adhesive layer. The average particle size of the colloidal metal compound is preferably from 1 to 100 nm, more preferably from 1 to 50 nm.

The colloidal metal compound to be used may be of various types. Examples of the colloidal metal compound include colloidal metal oxides such as colloidal alumina, colloidal silica, colloidal zirconia, colloidal titania, colloidal aluminum silicate, colloidal calcium carbonate, and colloidal magnesium silicate; colloidal metal salts such as colloidal zinc carbonate, colloidal barium carbonate and colloidal calcium phosphate; and colloidal minerals such as colloidal celite, colloidal talc, colloidal clay, and colloidal kaolin.

The colloidal metal compound may exist in the form of a colloidal solution, in which the colloidal metal compound is dispersed in a dispersion medium. The dispersion medium is generally water. Besides water, any other dispersion medium such as alcohols may also be used. The concentration of the colloidal metal compound solid in the colloidal solution is generally, but not limited to, from about 1 to about 50% by weight, more generally from 1 to 30% by weight. The colloidal metal compound to be used may contain a stabilizing agent of an acid such as nitric acid, hydrochloric acid and acetic acid.

The colloidal metal compound is electrostatically stabilized and may be classified into a positively charged one and a negatively charged one, while the colloidal metal compound is a non-electrically-conductive material. The positive charge and the negative charge are distinguished depending on the state of the colloidal surface charge in the solution after the preparation of the adhesive. For example, the charge of the colloidal metal compound may be determined by measuring the zeta potential with a zeta potential meter. The surface charge of the colloidal metal compound generally varies with pH. Thus, the charge of the colloidal solution state according to the invention is influenced by the controlled pH of the adhesive solution. The pH of the adhesive solution is generally set in the range of 2 to 6, preferably in the range of 2.5 to 5, more preferably in the range of 3 to 5, still more preferably in the range of 3.5 to 4.5. In the invention, the colloidal metal compound having a positive charge is more effective in reducing the occurrence of knicks than the colloidal metal compound having a negative charge. Examples of the colloidal metal compound having a positive charge include colloidal alumina, and colloidal titania. In particular, colloidal alumina is preferred.

The colloidal metal compound is added in an amount of 200 parts by weight or less (in solid weight) to 100 parts by weight of the polyvinyl alcohol-based resin. If the amount ratio of the colloidal metal compound is in the above range, the occurrence of knicks can be reduced, while the adhesion between the polarizer and the protective film can be ensured. The amount ratio of the colloidal metal compound is preferably from 10 to 200 parts by weight, more preferably from 20 to 175 parts by weight, still more preferably from 30 to 150 parts by weight. If the amount ratio of the colloidal metal compound is excess, adhesion properties may get worse. If the amount ratio is lower, a prevention of knicks may not be effective.

The adhesive for polarizing plate of the invention is a resin solution including the polyvinyl alcohol-based resin, the crosslinking agent and the colloidal metal compound with an average particle size of 1 to 100 nm and generally used in the form of an aqueous solution. While the resin solution may have any concentration, it preferably has a concentration of 0.1 to 15% by weight, more preferably of 0.5 to 10% by weight, in view of coatability, shelf stability and the like.

The viscosity of the resin solution, which is used as the adhesive for polarizing plate, is generally, but not limited to, from 1 to 50 mPa·s. In the preparation of conventional polarizing plates, the occurrence of knicks tends to increase as the viscosity of a resin solution decreases. Using the above adhesive composite, however, the occurrence of knicks can be prevented even in a low viscosity range such as the range of 1 to 20 mPa·s, and thus the occurrence of knicks can be prevented regardless of the viscosity of the resin solution. Polyvinyl alcohol-based resin having an acetoacetyl groups cannot have high degree of polymerization in contrast to other general polyvinyl alcohol resins, and therefore they are used at a low viscosity as mentioned above. According to the invention, however, knicks, which would otherwise be caused by the low viscosity of the resin solution, can be prevented from occurring even when the polyvinyl alcohol-based resin having an acetoacetyl group is being used.

The resin solution for use as the adhesive for polarizing plate may be prepared by any method. In general, the resin solution may be prepared by a process that includes mixing the polyvinyl alcohol-based resin and the crosslinking agent, appropriately adjusting the concentration thereof, and then adding the colloidal metal compound to the mixture. Optionally, a polyvinyl alcohol-based resin having an acetoacetyl group may be used as the polyvinyl alcohol-based resin. When the crosslinking agent is added in a relatively large amount, the stability of the solution may be taken into account, and therefore the mixing of the polyvinyl alcohol-based resin and the colloidal metal compound may be followed by the addition of the crosslinking agent in consideration of the timing of using the resulting resin solution and so on. The concentration of the resin solution for use as the adhesive for polarizing plate may be adjusted as appropriate, after the resin solution is prepared.

The adhesive for polarizing plate may also contain various types of tackifiers, coupling agents such as silane coupling agents, titanium coupling agents, stabilizing agents such as ultraviolet absorbing agents, antioxidants, heat-resistant stabilizing agents, and hydrolysis-resistant stabilizing agents, and so on. In the invention, the colloidal metal compound, which is a non-electrically-conductive material, may also contain fine particles of an electrically-conductive material.

The polarizing plate of the invention is manufactured by adhere the protective film to the polarizer with the adhesive. In the obtained polarizing plate, protective films are provided on both surfaces of a polarizer with an adhesive agent layer formed with the adhesive for polarizing plate interposed therebetween.

Coating of the adhesive may be performed on one/or both of the protective film and the polarizer. Coating of the adhesive is preferably conducted so as to achieve a thickness after drying of the order in the range of from 10 to 300 nm. The thickness of the adhesive layer is more preferably from 10 to 200 nm, still more preferably from 20 to 150 nm, in terms of achieving uniform in-plane thickness and sufficient adhesion force. At described above, the thickness of the adhesive layer is preferably designed to be larger than the average particle size of the colloidal metal compound contained in the adhesive for polarizing plate.

Examples of methods for controlling the thickness of the adhesive layer include, but are not limited to, methods including controlling the solid concentration of the adhesive solution or controlling an adhesive coater. While the thickness of the adhesive layer may be measured by any method, cross-sectional observation measurement by SEM (Scanning Electron Microscopy) or TEM (Transmission Electron Microscopy) is preferably used. The adhesive may be applied by any process, and various methods such as roll methods, spraying methods, and immersion methods may be used for the application.

After the adhesive is coated, the transparent protective is adhered to the polarizer with a roll laminator or the like. In the method for producing the polarizing plate of the invention, a moisture content of the polarizer to be subjected to the step of laminating the polarizer and the protective films is preferably from 12% by weight to 31% by weight, more preferably from 20% by weight to 27% by weight. When the moisture content of the polarizer to be subjected is in the above range, a reduction in the optical properties of the polarizing plate, a reduction of the adhesive force, and occurrence of knicks or unevenness can be prevented which would otherwise be caused by the process of drying after the lamination of the polarizer and the protective film with the adhesive interposed therebetween.

After the lamination of the polarizer and the protective film, the polarizing plate of the invention is preferably dried in an appropriate temperature. The drying step is preferably performed at a drying temperature of 90° C. or less, more preferably of 85° C. or less, still more preferably of 80° C. or less from a viewpoint of optical properties. The lower limit of the drying temperature is preferably, but not limited to, 50° C. or more from a viewpoint of manufacturing efficiency and practicability. The drying temperature may be stepwisely changed in the above range.

As shown in FIG. 2, a polarizing plate 10 of the present invention may be used in practical use as an optical film 20 laminated with other optical layers 11. Although there is especially no limitation about the optical layers 11, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a protective film etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside (backlight side) of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

A description of the elliptically polarizing plate or circularly polarizing plate in which the retardation plate is laminated to the polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal biaxial stretching and a biaxial stretched film as inclined alignment film etc. may be used. As inclined alignment film, for example, a film obtained using a method in which a heat shrinking film is adhered to a polymer film, and then the combined film is heated and stretched or shrunk under a condition of being influenced by a shrinking force, or a film that is aligned in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, a pressure-sensitive adhesive layer may also be prepared for adhesion with other members, such as a liquid crystal cell etc. As pressure-sensitive adhesive that forms pressure-sensitive layer is not especially limited, and, for example, acrylic-based resins; silicone-based resins; polyesters, polyurethanes, polyamides, polyethers; fluorine-based and rubber type resins may be suitably selected as a base polymer. Especially, a pressure-sensitive adhesive such as acrylics type pressure-sensitive adhesives may be preferably used, which is excellent in optical transparency, showing adhesion characteristics with moderate wettability, cohesiveness and adhesive property and has outstanding weather resistance, heat resistance, etc.

Moreover, a pressure-sensitive adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The pressure-sensitive adhesive layer may contain additives, for example, such as natural or synthetic resins, adhesive resins, glass fibers, glass beads, metal powder, fillers comprising other inorganic powder etc., pigments, colorants and antioxidants. Moreover, it may be a pressure-sensitive adhesive layer that contains fine particle and shows optical diffusion nature.

Proper method may be carried out to attach a pressure-sensitive adhesive layer to one side or both sides of the optical film. As an example, about 10 to about 40 weight % of the pressure-sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which a pressure-sensitive adhesive layer is once formed on a separator, as mentioned above, and is then transferred on a polarizing plate or an optical film may be mentioned.

A pressure-sensitive adhesive layer may also be prepared on one side or both sides of a polarizing plate or an optical film as a layer in which pressure-sensitive adhesives with different composition or different kind etc. are laminated together. Moreover, when pressure-sensitive adhesive layers are prepared on both sides, pressure-sensitive adhesive layers that have different compositions, different kinds or thickness, etc. may also be used on front side and backside of a polarizing plate or an optical film. Thickness of a pressure-sensitive adhesive layer may be suitably determined depending on a purpose of usage or adhesive strength, etc., and generally is 1 to 500 μm, preferably to 200 μm, and more preferably 1 to 100 μm.

A temporary separator is attached to an exposed side of a pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a protective film and an optical film etc. and a pressure-sensitive adhesive layer, using a method of adding UV absorbents, such as salicylic acid ester type compounds, benzophenol type compounds, benzotriazol type compounds, cyano acrylate type compounds, and nickel complex salt type compounds.

A polarizing plate or an optical film of the present invention may be preferably used for manufacturing various equipments, such as liquid crystal display, etc. Assembling of a liquid crystal display may be carried out according to conventional methods. That is, as shown in FIG. 3, a liquid crystal display 100 is generally manufactured by suitably assembling several parts such as a liquid crystal cell 30, polarizing plates 10 or optical films 20 and, if necessity, lighting system 50, and by incorporating driving circuit. In the present invention, except that a polarizing plate or an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned polarizing plate or optical film has been located at one side or both sides of the liquid crystal cell, and with which a backlight or a reflector is used for a lighting system may be manufactured. In this case, the polarizing plate or optical film by the present invention may be installed in one side or both sides of the liquid crystal cell. When installing the polarizing plate or optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro-luminescence equipment (organic EL display) will be explained. Generally, in organic EL display, a transparent electrode, an organic emitting layer and a metal electrode are laminated on a transparent substrate in an order configuring an illuminant (organic electro-luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic emitting layer is formed by a very thin film about 10 nm in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic electro-luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

The invention is further described using the EXAMPLEs and the COMPARATIVE EXAMPLEs below, which are not intended to limit the scope of the invention. The analytical methods below were each used in the EXAMPLEs.

### Zinc Content

The content of zinc in the polarizer was measured with a fluorescent X-ray analyzer (ZSX, manufactured by Rigaku Corporation).

### Water-Vapor Permeability

The water-vapor permeability of the film was measured as the gram weight of water vapor passing through a sample with an area of 1 m² for 24 hours at a temperature of 40° C. and a relative humidity of 90% by the water-vapor permeability test (cup method) according to JIS Z 0208.

### Average Particle Size

An aqueous colloidal alumina solution was measured with a particle size distribution meter (Nanotrac UPA150, manufactured by Nikkiso Co., Ltd.) by dynamic light scattering (optical correlation technique).

### Viscosity of Aqueous Adhesive Solution

The prepared aqueous adhesive solution (room temperature: 23° C.) was measured with a rheometer (RSI-HS, manufactured by Haake).

### Transmittance and Degree of Polarization

A measurement of the transmittance of a polarizer (single-piece transmittance) was performed by a spectrophotometer (DOT-3, manufactured by Murakami Color Research Laboratory). Then the transmittances of a lamination of two pieces of the same polarizing plates in such a manner that their transmission axes are parallel (parallel transmittance: H₀) and that their transmission axes are orthogonal (crossed transmittance: H₉₀). The degree of polarization was calculated from the formula below.

Degree of Polarization (%)={(H₀−H₉₀)/(H₀+H₉₀)}^{1/2}×100

The single-piece transmittance, the parallel transmittance (H₀), and the crossed transmittance (H₉₀) above are Y values which have undergone luminosity correction in the two-degree visual field (C illuminant) according to JIS Z 8701.

### Orthogonal Chromaticity

The orthogonal chromaticity of the polarizing plate was measured using a value of the Hunter color system and a spectrophotometer (DOT-3, manufactured by Murakami Color Research Laboratory).

### Heat Resistance Test

The orthogonal chromaticity of the polarizing plate (a₀ and a₅₀₀) was measured at the initial point and after it was held at 105° C. for 500 hours.

### Humidity Resistance Test

The polarizing plate was placed in a thermo-hygrostat at 85° C. and 85% RH for 500 hours and then measured for degree of polarization. The amount of the change in degree of polarization from the initial value was calculated (ΔP₅₀₀).

### Appearance Test: Knick Defects

The polarizing plate was cut into two square pieces each with a size of 1000 mm×1000 mm. The two polarizing plate pieces were stacked above a fluorescent lamp with a luminance of 8,000 cd/m² such that their transmission axes were orthogonal to each other, and in this configuration, light leakage portions (knick defects) were visually counted.

### Measurement of Amount of Peeling

The polarizing plate was cut 50 mm long in the direction of the absorption axis and 25 mm long in the direction perpendicular to the absorption axis so that a rectangular sample was prepared. The sample was immersed in hot water at 60° C. for 5 hours and then taken out of the hot water. The length of the peeling portion of the protective film at the edge of the sample was measured with a vernier caliper which was of JIS First Class.

### Example 1

### Preparation of Polarizer

A 75 μm-thick polyvinyl alcohol film with an average degree of polymerization of 2,700 was stretched and fed, while it was dyed between rolls having different peripheral speed ratios. First, the polyvinyl alcohol film was stretched in the feeding direction to 1.2 times, while it was immersed in a water bath at 30° C. for 1 minute and allowed to swell. Thereafter, the film was stretched in the feeding direction to 3 times the original unstretched state, while it was immersed and dyed in an aqueous solution (bath) of 0.03% by weight of potassium iodide and 0.3% by weight of iodine at 30° C. for 1 minute. The film was then stretched in the feeding direction to 6 times the original unstretched state, while it was immersed in an aqueous solution (bath) of 4% by weight of boric acid, 5% by weight of potassium iodide and 2.5% by weight of zinc sulfate at 60° C. for 30 seconds. The stretched film was then dried at 70° C. for 2 minutes to give a polarizer. The resulting polarizer had a thickness of 30 μm, a zinc content of 0.20% by weight and a moisture content of 25.0% by weight.

### Protective Film

A norbornene resin film (ZEONOR Film (40 μm in thickness) manufactured by Nippon Zeon Co., Ltd.) was used as the protective film. The film had a water-vapor permeability of 5 g/m² per 24 hours.

### Preparation of Adhesive

An aqueous solution with a solids content of 3.7% by weight was prepared by dissolving 100 parts by weight of an acetoacetyl group-containing polyvinyl alcohol resin (1,200 in average degree of polymerization, 98.5% in degree of saponification and 5% by mole in degree of acetoacetylation) and 50 parts by weight of methylol melamine in pure water at a temperature of 30° C. An aqueous adhesive solution was prepared by mixing 100 parts by weight of the resulting aqueous solution with 18 parts by weight of an aqueous solution of colloidal alumina (15 nm in average particle size, 10% by weight in solids content, positively charged). The adhesive solution had a viscosity of 9.6 mPa·s and a pH of 4 to 4.5. The amount of the colloidal alumina was 74 parts by weight, based on 100 parts by weight of the polyvinyl alcohol resin.

### Preparation of Polarizing Plate

The adhesive was applied to one side of the protective film such that the adhesive layer would have a thickness of 80 nm after drying. The adhesive-coated protective film was bonded to both sides of the zinc-containing polarizer with a roller machine and dried at 55° C. for 6 minutes so that a polarizing plate was prepared.

### Example 2

### Protective Film

Ninety parts by weight of a poly(methyl methacrylate) resin with a photoelastic coefficient of 5×10⁻¹² (m²/N) (ACRYPET VH, manufactured by Mitsubishi Rayon Co., Ltd.) and 10 parts by weight of an acrylonitrile-styrene copolymer (STYLAC AS, manufactured by Asahi Kasei Corporation) acting to cancel the birefringence of the resin were dissolved and extruded through a T-die and formed into a film on a casting roll. The film was then stretched to 1.8 times in machine direction by a zone drawing method so that a poly(methyl methacrylate) film having uniaxial molecular orientation was obtained. The uniaxially oriented film was then stretched to 2.2 times in transverse direction by a tenter stretching method so that a 40 μm-thick film was obtained that was mainly composed of the poly(methyl methacrylate) and had biaxial molecular orientation. The resulting film had a water-vapor permeability of 90 g/m² per 24 hours.

### Preparation of Polarizing Plate

A polarizing plate was prepared in the same manner as in EXAMPLE 1, except that the film mainly made of the poly(methyl methacrylate) described above was used as the protective film.

### Example 3

### Preparation of Adhesive

An adhesive was prepared in the same manner as in EXAMPLE 1, except that the amount of the addition of the aqueous solution of colloidal alumina (15 nm in average particle size, 10% by weight in solids content, positively charged) was controlled such that 140 parts by weight of the colloidal alumina was mixed with 100 parts by weight of the polyvinyl alcohol resin.

### Preparation of Polarizing Plate

A polarizing plate was prepared in the same manner as in EXAMPLE 1, except that the adhesive described above was used instead.

### Example 4

### Preparation of Adhesive

An adhesive was prepared in the same manner as in EXAMPLE 1, except that an aqueous solution of colloidal alumina (75 nm in average particle size, 10% by weight in solids content, positively charged) was used instead.

### Preparation of Polarizing Plate

A polarizing plate was prepared in the same manner as in EXAMPLE 1, except that the adhesive described above was used instead.

### Comparative Example 1

### Preparation of Polarizer

A zinc-free polarizer was prepared in the same manner as in EXAMPLE 1, except that zinc sulfate was not added to the bath used in the process of stretching the polyvinyl alcohol film to 6 times.

### Preparation of Polarizing Plate

A polarizing plate was prepared in the same manner as in EXAMPLE 1, except that the zinc-free polarizer was used instead.

### Comparative Example 2

### Protective Film

A triacetylcellulose film (KC4UWY, 40 μm in thickness, manufactured by Konica Minolta) was used. The film had a water-vapor permeability of 400 g/m² per 24 hours.

### Preparation of Polarizing Plate

A polarizing plate was prepared in the same manner as in EXAMPLE 1, except that the triacetylcellulose film above was used as the protective film.

### Comparative Example 3

### Preparation of Polarizer

A 75 μm-thick polyvinyl alcohol film with an average degree of polymerization of 2,700 was immersed in a water bath at 30° C. and allowed to swell. Thereafter, the film was stretched to about 3 times in a dyeing bath of an aqueous solution of a commercially available dichroic dye (Congo Red, manufactured by Kishida Chemical Co., Ltd.) (at a concentration of 1% by weight) at 30° C. The film was then stretched in a crosslinking bath of an aqueous solution of 3% by weight boric acid at 50° C. such that the total stretch ratio reached 6 times. The film was further crosslinked in an aqueous solution of 4% by weight boric acid at 30° C. The film was then dried at 50° C. for 4 minutes to give a polarizer, which contained the absorbing dichroic dye instead of iodine.

### Preparation of Polarizing Plate

A polarizing plate was prepared in the same manner as in COMPARATIVE EXAMPLE 2, except that the dye polarizer described above was used instead.

### Comparative Example 4

### Preparation of Adhesive

An aqueous adhesive solution was prepared in the same manner as in EXAMPLE 1, except that the aqueous solution of colloidal alumina was not added when the adhesive was prepared.

### Preparation of Polarizing Plate

A polarizing plate was prepared in the same manner as in EXAMPLE 1, except that the adhesive described above was used instead.

### Comparative Example 5

### Preparation of Adhesive

An adhesive was prepared in the same manner as in EXAMPLE 1, except that the amount of the addition of the aqueous solution of colloidal alumina (15 nm in average particle size, 10% by weight in solids content, positively charged) was controlled such that 300 parts by weight of the colloidal alumina was mixed with 100 parts by weight of the polyvinyl alcohol resin.

### Preparation of Polarizing Plate

A polarizing plate was prepared in the same manner as in EXAMPLE 1, except that the adhesive described above was used instead.

### Comparative Example 6

### Preparation of Adhesive

An adhesive was prepared in the same manner as in EXAMPLE 1, except that an aqueous solution of colloidal alumina (1 nm in average particle size, 10% by weight in solids content, positively charged) was used instead.

### Preparation of Polarizing Plate

A polarizing plate was prepared in the same manner as in EXAMPLE 1, except that the adhesive described above was used instead.

Table 1 shows the preparation conditions and the evaluation results with respect to the polarizing plates obtained in EXAMPLEs 1 to 4 and COMPARATIVE EXAMPLEs 1 to 6.

TABLE 1

| | Conditions of Preparation of Polarizing Plate | | | | | Evaluation Results | | | |
|---|---|---|---|---|---|---|---|---|---|
| | | | | Adhesive | | Optical Properties | | | |
| | Protective Film | | | Alumina | | Single- | | | |
| | Water-Vapor | Polarizer | | | Average | Peace | | | Degree of |
| | Permeability | | Dichroic | Amount | Particle | Transmit- | H₀ | | Polarization |
| | (g/m² · 24 h) | Zinc | Material | (parts) | Size (nm) | tance (%) | (%) | H₉₀ (%) | (%) |
| Example 1 | 5 | Present | Iodine | 74 | 15 | 42.637 | 36.453 | 0.002 | 99.994 |
| Example 2 | 90 | Present | Iodine | 74 | 15 | 42.636 | 36.454 | 0.002 | 99.994 |
| Example 3 | 5 | Present | Iodine | 140 | 15 | 42.637 | 36.453 | 0.003 | 99.994 |
| Example 4 | 5 | Present | Iodine | 74 | 75 | 42.636 | 36.452 | 0.002 | 99.994 |
| COMPARATIVE | 5 | Absent | Iodine | 74 | 15 | 43.043 | 36.761 | 0.015 | 99.959 |
| EXAMPLE 1 | | | | | | | | | |
| COMPARATIVE | 400 | Present | Iodine | 74 | 15 | 42.349 | 35.624 | 0.003 | 99.991 |
| EXAMPLE 2 | | | | | | | | | |
| COMPARATIVE | 400 | Absent | Dye | 74 | 15 | 40.420 | 29.518 | 2.831 | 90.827 |
| EXAMPLE 3 | | | | | | | | | |
| COMPARATIVE | 5 | Present | Iodine | 0 | — | 42.635 | 36.453 | 0.003 | 99.994 |
| EXAMPLE 4 | | | | | | | | | |
| COMPARATIVE | 5 | Present | Iodine | 300 | 15 | 42.630 | 36.451 | 0.003 | 99.993 |
| EXAMPLE 5 | | | | | | | | | |
| COMPARATIVE | 5 | Present | Iodine | 74 | 1000 | 42.605 | 35.765 | 1.104 | 96.959 |
| EXAMPLE 6 | | | | | | | | | |

| | Evaluation Results | | | | |
|---|---|---|---|---|---|
| | | | Humidity | Appearance | Amount |
| | Heat Resistance | | Resistance | Number of | of Peeling |
| | a0 (NBS) | a500 (NBS) | ΔP₅₀₀ (%) | Knicks (counts) | (mm) |
| Example 1 | 0.415 | 0.383 | −3.370 | 0 | 0 |
| Example 2 | 0.415 | 0.383 | −3.371 | 0 | 0 |
| Example 3 | 0.416 | 0.383 | −3.372 | 0 | 1 |
| Example 4 | 0.416 | 0.383 | −3.370 | 0 | 0 |
| COMPARATIVE | 0.468 | 1.301 | −3.370 | 0 | 1 |
| EXAMPLE 1 | | | | | |
| COMPARATIVE | 0.304 | 0.041 | −52.770 | 1 | 0 |
| EXAMPLE 2 | | | | | |
| COMPARATIVE | −3.597 | −1.753 | −1.377 | 1 | 1 |
| EXAMPLE 3 | | | | | |
| COMPARATIVE | 0.415 | 0.383 | −3.369 | 24 | 1 |
| EXAMPLE 4 | | | | | |
| COMPARATIVE | 0.414 | 0.383 | −3.367 | 1 | 5 |
| EXAMPLE 5 | | | | | |
| COMPARATIVE | 0.415 | 0.383 | −3.369 | 7 | 2 |
| EXAMPLE 6 | | | | | |

A comparison between each EXAMPLE and COMPARATIVE EXAMPLE 1 or 2 indicates that the addition of zinc to the polarizer and the use of the protective film with low moisture permeability increase the durability of the polarizing plate. A comparison between each Example and COMPARATIVE Example 3 indicates that when a dye-containing polarizer is used, low optical properties (degree of polarization) are provided, although high durability is provided.

A comparison between each Example and COMPARATIVE Examples 4 to 6 indicates that the addition of an appropriate amount of a colloidal metal compound with an appropriate particle size to the pressure-sensitive adhesive allows the production of a polarizing plate with no separation of the pressure-sensitive adhesive and with good appearance.

What is claimed is:

1. A polarizing plate, comprising:
a polarizer including an iodine-containing polyvinyl alcohol resin and containing zinc;
protective films each having a water-vapor permeability of 150 g/m² per 24 hours or less in an atmosphere at 40° C. and 90% RH; and
an adhesive including a polyvinyl alcohol-based resin, a crosslinking agent and a colloidal metal compound with an average particle size of 1 nm to 100 nm, wherein
the protective films are bonded to both side of the polarizer with the adhesive interposed between the protective film and the polarizer.

2. The polarizing plate according to claim 1, wherein an amount of the colloidal metal is 200 parts by weight or less based on 100 parts by weight of the polyvinyl alcohol-based resin.

3. The polarizing plate according to claim 1, wherein the colloidal metal compound has a positive charge.

4. The polarizing plate according to claim 3, wherein the colloidal metal compound is colloidal alumina.

5. The polarizing plate according to claim 1, wherein the polyvinyl alcohol-based resin has an acetoacetyl group.

6. The polarizing plate according to claim 1, wherein the adhesive layer has a thickness of 10 nm to 300 nm, and the thickness of the adhesive layer is larger than the average particle size of the colloidal metal compound.

7. The polarizing plate according to claim 1, wherein the crosslinking agent contains a methylol group-containing compound.

8. The polarizing plate according to claim 1, wherein an amount of the crosslinking agent is of 10 to 60 parts by weight based on 100 parts by weight of the polyvinyl alcohol-based resin.

9. The polarizing plate according to claim 1, wherein the polarizer has a zinc content of 0.002% by weight to 2% by weight.

10. A method for producing the polarizing plate according to claims 1 that comprises a polarizer and protective films placed on both sides of the polarizer with an adhesive interposed between the polarizer and the protective film, the method comprising the steps of:
applying the adhesive to the polarizer and/or the protective films, wherein the adhesive including a polyvinyl alcohol resin, a crosslinking agent and a colloidal metal compound with an average particle size of 1 nm to 100 nm, wherein the polarizer including an iodine-containing polyvinyl alcohol resin and containing zinc, and wherein the protective film having a water-vapor permeability of 150 g/m² per 24 hours or less in an atmosphere at 40° C. and 90% RH;
laminating the polarizer and the protective films; and
drying the laminate of the polarizer and the protective film.

11. The method according to claim 10, wherein the polarizer to be subjected to the step of laminating the polarizer and the protective films has a moisture content of 12% by weight to 31% by weight.

12. The method according to claim 10, wherein the drying step is performed at a drying temperature of 90° C. or less.

13. An optical film, comprising a laminate including at least one piece of the polarizing plate according to claim 1.

14. An image display device, comprising the polarizing plate according to claim 1.

15. An image display device, comprising the optical film according to claim 13.
